(19) United States
(12) Patent Application Publication
(10) Pub. No.: US 2011/0027499 A1
(43) Pub. Date: Feb. 3, 2011

(54) RADIATION-ASSISTED NANOPARTICLE PRINTING

(75) Inventors: Heiko Wolf, Pfaeffikon (CH); Tobias Kraus, Saarbrucken (DE); Andrea Decker, Basel (CH)

Correspondence Address: IBM CORPORATION, T.J. WATSON RESEARCH CENTER, P.O. BOX 218, YORKTOWN HEIGHTS, NY, 10598, US

(73) Assignee: INTERNATIONAL BUSINESS MACHINES CORPORATION, Armonk, NY (US)

(21) Appl. No.: 12/512,975

(22) Filed: Jul. 30, 2009

(51) Int. Cl. B05D 3/06

(52) U.S. Cl. 427/555

(57) ABSTRACT

A method of nanoparticle printing including: contacting a printing plate with a target substrate, while the printing plate is contacting the target substrate, illuminating nanoparticies on the printing plate with intense flashes of LASER light, or subjecting the nanoparticles to microwave radiation, such that energy is selectively transferred into the particles, increasing a local temperature of the particles which causes an increased interaction of the particles with the target substrate and produces a strong junction and removes the particles from the printing plate; and peeling off the printing plate from the target substrate.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### NAMES OF THE PARTY TO A JOINT RESEARCH AGREEMENT

(Not Applicable)

### INCORPORATION-BY-REFERENCE OF MATERIAL SUBMITTED ON A COMPACT DISC

(Not Applicable)

### BACKGROUND OF THE INVENTION

(1) Field of the Invention

This disclosure is directed to methods, systems and apparatus for radiation-assisted nanoparticle printing.

(2) Description of Related Art Including Information Submitted under 37 CFR 1.97 and 1.98

Printing is used to deposit particles onto surfaces. Nanoparticles, for example particles less than 100 nm in diameter, are increasingly being utilized in a number of technologies.

### BRIEF SUMMARY OF THE INVENTION

At least some aspects of this disclosure are directed to methods, systems and apparatus for radiation-assisted nanoparticle printing.

In particular, at least some aspects of this disclosure are directed to a method of nanoparticle printing, including: contacting a printing plate with a target substrate, while the printing plate is contacting the target substrate, illuminating nanoparticles on the printing plate with intense flashes of LASER light, or subjecting the nanoparticles to microwave radiation, such that energy is selectively transferred into the particles, increasing a local temperature of the particles which causes an increased interaction of the particles with the target substrate and produces a strong junction and removes the particles from the printing plate; and peeling off the printing plate from the target substrate.

Also, at least some aspects of this disclosure are directed to a system and/or apparatus for conducting such methods.

Other exemplary embodiments and advantages of this disclosure can be ascertained by reviewing the present disclosure and the accompanying drawing.

### BRIEF DESCRIPTION OF THE SEVERAL VIEWS OF THE DRAWING(S)

This disclosure is further described in the detailed description that follows, with reference to the drawing, in which: the figure illustrates a template on a substrate for nanoparticle printing in accordance with at least some aspects of this disclosure.

### DETAILED DESCRIPTION OF THE INVENTION

Exemplary embodiments of this disclosure are described herein by way of example.

Nanoparticles (NPs) have a number of applications that can require arrangement and integration of the nanoparticles on surfaces. Nanoparticle printing can provide larger efficiency and versatility than other methods, but has required an adhesion cascade that can limit the systems for which nanoparticle printing can be applicable. This disclosure is directed to methods, systems, and apparatus that can broaden the systems for which nanoparticle printing can be utilized.

Nanoparticle printing is an efficient method to arrange and integrate particles on a surface. As mentioned above, nanoparticle printing has required an adhesion cascade to transfer the particles from the printing plate to the target substrate. One approach is to cover the target substrate with a thin polymer layer and to heat it such that the particles form a large interface with the polymer layer, yielding adhesion strength sufficient for particle transfer. If the increased temperature or the adhesion layer are not feasible, either because the materials are too sensitive or because the thermal expansion would lower the printing precision, an alternative route can be utilized.

In the embodiments of this disclosure, electromagnetic radiation is utilized to transfer the nanoparticles from their printing plate onto the target substrate, with or without an additional adhesion layer. In at least some embodiments, the nanoparticles can have, for example, an average diameter of less than 500 nm. In at least some of these embodiments, the nanoparticles can have, for example, an average diameter of less than 250 nm. Further in at least some of these embodiments, the nanoparticles can have, for example, an average diameter of less than 100 nm.

Examples of materials for the nanoparticles include metal particles, semiconductor particles, oxide particles, Pt, Ag, Au, polystyrene, and/or silica. In some embodiments, the nanoparticles can contain a dye that makes the nanoparticles sensitive to a certain wavelength.

When the printing plate and the target substrate are in contact, the particles are illuminated with intense flashes of LASER light, or subjected to microwave radiation or another form of radiation capable of transferring energy selectively into the nanoparticles. The local temperature increase leads to an increased interaction of the nanoparticles with the target substrate, produces a strong junction and removes them from the printing plate, which can thus be peeled off.

Thus, the disclosure relates to a method for radiation-assisted nanoparicle printing where, in at least some embodiments, nanoparticles are selectively heated, e.g. by means of a laser or microwave radiation, thereby generating an increased interaction of the nanoparticles with the target substrate.

When electromagnetic radiation is utilized, exemplary radiation wavelengths that can be utilized include, generally, any electromagnetic radiation that the NP can absorb; for example, wavelengths greater than 240 nm (UV, visible, IR, microwaves). Particular examples of wavelengths that can be utilized include green laser light (532 nm) for Au NPs. The radiation can be pulsed or continuous wave (CW). A particular example that can be utilized is a laser (532 nm) with power of 4.5 watts for from 5 seconds to 60 seconds for transfer of Au NPs of from 50 to 100 nm.

Examples of some of the materials that can be utilized for the printing plate include an elastomer or supported elastomer that is transparent to the wavelength being utilized. Particular examples that can be utilized for the printing plate include polydimethylsiloxane (PDMS) or PDMS on a glass or quartz slide, for example a thin PDMS-layer (for example from 10 micrometers to 500 micrometers thick, or from 10 micrometers to 300 micrometers thick or from 10 micrometers to 200 micrometers thick) on a thin glass or quartz slide (for example from 50 micrometers to 500 micrometers thick or from 100 to 350 micrometers thick or from 150 to 200 micrometers thick).

Some examples of the materials that can be utilized for the substrate include: glass, Si/SO₂, semiconductor material, polymeric material, etc. The substrate can be with or without an additional adhesion layer. Particular examples of the material that can be utilized for the substrate include glass, Si/SiO₂ or semiconductor material coated with a thin thermoplastic polymer, for example a thin layer of polymethylmethacrylate (PMMA). The thickness of the PMMA layer can be, for example, up to 200 nm, for example from 5 to 100 nm, or from 5 to 30 nm.

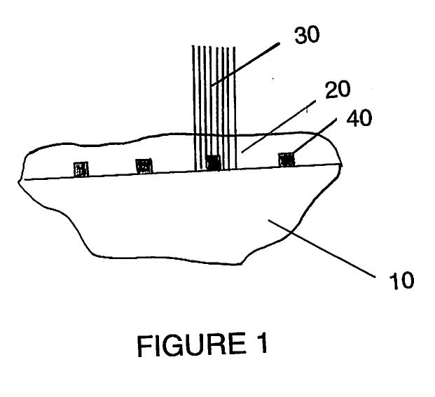

FIG. 1 provides an example of utilizing a laser 30 to print nanoparticles 40 from a printing plate or template 20 onto a substrate 10. In the exemplary FIG. 1, the substrate 10 is an Si substrate The nanoparticles 40 can be, for example, Au NPs.

Once the nanoparticles 40 in FIG. 1 are printed onto the substrate 10, the printing plate 20 can be peeled off from the substrate 10.

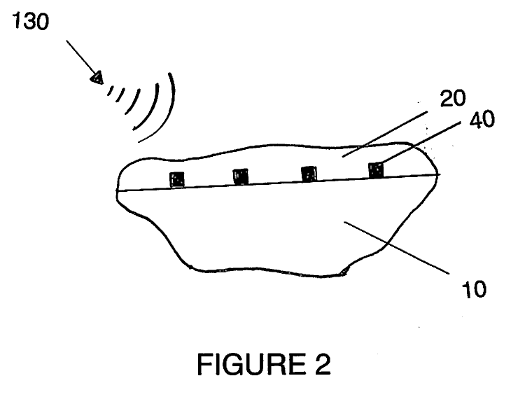

FIG. 2 provides an example of utilizing radio frequency microwaves 130 to print nanoparticles 40 from a printing plate or template 20 onto a substrate 10. In the exemplary FIG. 2, the substrate 10 is again an Si substrate. The nanoparticles 40 can be, for examples Au NPs.

Once the nanoparticles 40 in FIG. 2 are printed onto the substrate 10, the printing plate 20 can be peeled off from the substrate 10.

In an alternative embodiment, the nanoparticles can be printed utilizing a combination of a laser 30 (FIG. 1) and radio frequency microwaves 130 (FIG. 2).

The foregoing exemplary embodiments have been provided for the purpose of explanation and are in no way to be construed as limiting this disclosure. This disclosure is not limited to the particulars disclosed herein, but extends to all embodiments within the scope of the appended claims, and any equivalents thereof.

What is claimed:

1. A method of nanoparticle printing, comprising:
contacting a printing plate with a target substrate,
while the printing plate is contacting the target substrate, illuminating nanoparticles on the printing plate with intense flashes of LASER light, or subjecting the nanoparticles to microwave radiation, such that energy is selectively transferred into the particles, increasing a local temperature of the particles which causes an increased interaction of the particles with the target substrate and produces a strong junction and removes the particles from the printing plate; and
peeling off the printing plate from the target substrate.
